(19) United States
(12) Patent Application Publication
(10) Pub. No.: US 2013/0234597 A1
(43) Pub. Date: Sep. 12, 2013

(54) PLASMA SHIELD DEVICE AND PLASMA SOURCE APPARATUS

(71) Applicant: LASERTEC CORPORATION, Yokohama-shi (JP)

(72) Inventors: Haruhiko KUSUNOSE, KANAGAWA (JP); Kiwamu TAKEHISA, KANAGAWA (JP); Tomohiro SUZUKI, KANAGAWA (JP); Hiroki MIYAI, KANAGAWA (JP)

(73) Assignee: LASERTEC CORPORATION, YOKOHAMA-SHI (JP)

(21) Appl. No.: 13/788,005

(22) Filed: Mar. 7, 2013

(30) Foreign Application Priority Data
Mar. 9, 2012 (JP) 2012-052555

(51) Int. Cl. H01J 1/52; H05H 1/24

(52) U.S. Cl. CPC H01J 1/52; H05H 1/24
USPC 315/111.21; 313/356; 313/231.31

(57) ABSTRACT

The plasma shield device (13) comprises a hollow structure (40) made of monocrystal body of silicon carbide and having an inside space (40a) and a first and second openings (40b,40c) which are opposed to each other across the inside space. During operation of the plasma generation apparatus, the internal space of the hollow structure forms a discharge zone in which the plasma is generated. Discharge gas is supplied to the internal space of the hollow structure through the first opening and the EUV radiation is mainly emitted through the second opening.

### TECHNICAL FIELD

The present invention relates to a plasma shield device for shielding high temperature plasma. The present invention also relates to a plasma source apparatus for emitting EUV radiation.

### BACKGROUND ART

As a light source used in an exposure equipment or mask inspection apparatus of next generation, an EUV (Extreme Ultraviolet) source for emitting EUV radiation whose wavelength is 13.5 nm or 6.7 nm have been developed. As the EUV source, Discharge Produced Plasma method (DPP method) for generating the high temperature plasma by using current pulse and Laser Produced Plasma method (LPP method) for generating the high temperature plasma by irradiating laser beam toward a target have been developed.

The plasma source comprises a discharge chamber in which a discharge head for producing the plasma is arranged and an optical chamber in which light collection system for focusing the EUV radiation beam to a middle focusing point is arranged. Since the generated plasma is high temperature and has sputtering action, electrodes are sputtered and the problem arises that debris is generated. If the debris is generated, then the collection mirror is contaminated and the reflectivity of the collection mirror is substantially decreased. For this reason, a debris shield device (filter device) is arranged between the discharge chamber and the optical system chamber in order to prevent the generated debris from penetrating into the optical system chamber.

In order to suppress the generation of the debris, in the prior plasma source, the heat resisting material such as a ceramics material or a alumina material of silicon carbide is used (for example, see PLT 1). Silicon carbide has good durability for the heat shock due to its good heat resisting property.
PLT 1: Japanese Patent Publication (A) No. 2006-520107

### SUMMARY OF INVENTION

### Technical Problem

The debris shield device is required to shield the debris generated in the discharge chamber and to selectively transmit the EUV radiation only. For this reason, in the prior debris shield device, a foil of zirconium having thickness of about 400 nm has been used. However, since the sputtering action of the high temperature plasma is stronger, the debris having considerably high kinetic energy has frequently generated and the debris shield foil has been damaged in a short period of time. Therefore, the problem arises that the replacement of the debris shield device becomes frequent. In order to solve such problem, it is considered that the thickness of the debris shield foil is increased so as to enhance the mechanical strength of the debris shield foil. But, if the debris shield foil is thicker, then the problem arises that the intensity of EUV radiation transmitted through the debris shield foil is decreased.

An object of the present invention is to realize a plasma shield device in which the generation of the debris is considerably reduced.

Another object of the invention is to provide a plasma shield device in which the exchange frequency of the debris shield foil can be reduced without thickening the foil.

Another object of the invention is to provide a plasma source apparatus in which the generation of the debris can be considerably reduced.

### Solution to Problem

The plasma shield device according to the invention comprising;

a hollow structure having an internal space, and a first and second opening which are opposed to each other across the inside of the internal space, wherein

the hollow structure comprises of monocrystal body of silicon carbide, and wherein

the internal space of the hollow structure forms a discharge space in which the plasma is generated during the operation of the plasma generation apparatus.

The basic aspect of the present invention is to apply a monocrystal (single crystal) of silicon carbide (SiC) to a mechanical component. Since the silicon carbide has excellent heat resisting property and electric insulation quality as well as good thermal conductivity, the silicon carbide is used as a substrate of a power semiconductor device. On the contrary, according to the invention, using the feature of the monocrystal of the silicon carbide in which two elements of “Si” and “C” are regularly arranged, the monocrystal of silicon carbide (SiC) is applied to the mechanical component which requires the heat resisting property and the sputtering resisting property.

The plasma generated in the plasma source apparatus is high temperature and has strong sputtering action. Therefore, it is necessary to provide the plasma source apparatus with the plasma shield device for shielding the generated plasma from electrodes or a discharge circuit. In this regard, the silicon carbide has the durability to temperature of 1,400 degrees Celsius and also has the superior durability to the thermal shock. Therefore, from a heat resisting point of view, the silicon carbide is suitable material as the structure component of the plasma shield device. However, in the prior plasma source apparatus, the silicon carbide ceramics or the alumina material is used as the electrode material, and thus the problem arises that the debris is frequently generated. The inventor analyzed such problem, and as a result it has been found that the generation of the debris and the damage for the debris shield foil is caused by the fact that the silicon carbide ceramics is composed of polycrystalline substance. That is, the silicon carbide ceramics is polycrystalline substance and is an aggregate of fine monocrystal substances of silicon carbide. Therefore, there are grain boundaries between the adjacent microcrystal substances. Since the combining force of the grain boundary is relatively weak, the combination between the grain boundaries comes off and thus fine monocrystals are generated when the surface of the silicon carbide ceramics is exposed by the high temperature plasma. Especially, when the size of the crystal is bigger, the debris having high kinetic energy is generated and penetrates through the debris shield foil. In this way, in the prior plasma source apparatus, the generation of the debris is caused by the fact that the silicon carbide ceramics is polycrystalline substance.

On the basis of the above analysis result, according to the invention, the plasma shield device is composed of the hollow structure consisting of the monocrystal of the silicon carbide. The monocrystal body of silicon carbide comprises a three dimensional structure in which the elements of “Si” and “C” are regularly arranged, and the combining forces acted between the adjacent elements are much stronger than those formed between the grain boundaries of the polycrystalline of silicon carbide. Therefore, since the monocrystal body of silicon carbide does not include any local portions with weak combining force unlike the polycrystalline, the generation of the debris is substantially reduced when it is exposed by the high temperature plasma. Furthermore, the monocrystal body of the silicon carbide is a structure in which the elements of “Si” and “C” are regularly arranged, and therefore when the surface of the monocrystal body of the silicon carbide is exposed by the high temperature plasma, only the elements located outward (on the surface) is sputtered, the elements located inside is not sputtered. Therefore, the size of the scattered debris is much smaller than that of the debris generated when the polycrystalline of silicon carbide is sputtered. As the size of the scattered debris is smaller, the kinetic energy of the debris impinging on the debris shield foil is also small, and thus the probability that the foil of zirconium is damaged is substantially reduced. As the result of this, the life of the debris shield device becomes longer, and the exchange frequency of the debris shield device is substantially reduced. Furthermore, since the large size debris is not scattered, it is possible to thin the debris shield foil. As the result of this, the intensity of the EUV radiation transmitted through the debris shield foil and directed into the collection optical system is substantially increased. In this way, by using the hollow structure made of the monocrystal of silicon carbide as the plasma shield device, the plasma shield device having both of the heat resisting property and the sputtering resistant property can be realized.

A ingot of monocrystalline SiC having a diameter of three inches have been manufactured by sublimation recrystallization method (Modified Lely Method) and is available. Therefore, it is possible to manufacture the hollow structure having given size and shape from the ingot of monocrystalline SiC by mechanical processing, and also it is possible to manufacture the plasma shield devices which adapt to various applications.

Next, preliminary experiments which are technical ground of the invention will be explained. The inventor performed various preliminary experiments for checking the damaged state of the debris shield foil of zirconium by using the plasma source apparatus, and following technical result has been found. As an experimental equipment, a plasma generation apparatus of ICP type shown in FIG. 1, which is provided with the plasma shield device of silicon carbide ceramics whose thickness is 400 nm. A photo-detector for detecting the visible light is arranged behind the debris shield foil in order to detect the visible light transmitted through the shield foil. The high temperature plasma produces the EUV radiation and visible light, and the debris shield foil of zirconium transmits the EUV radiation and blocks the visible light. If the debris shield foil is normal, then the visible light is not detected by the detector. But, if the debris shield foil is damaged, then the visible light passes through the damaged portion of the foil and is detected by the detector. Therefore, it is possible to grasp the damaged state of the debris shield foil by detecting the visible light passing through the foil.

In the experiments, the plasma was produced by supplying current pulses at predetermined frequency repeatedly. After the generation of the plasma was repeated at many times, the visible light whose brightness increased instantaneously was detected. When the visible light was detected, the damaged state of the debris shield foil was observed by using a microscope. As the result of the observation, a relatively large through hole having a diameter of about several 100 micrometers has been formed in the debris shield foil. From this experimental result, it is considered that the relatively large debris having a diameter of about several 10 micrometers˜several 100 micrometers was instantaneously generated and impinged on the shield foil so that the debris shield foil was damaged by the scattered debris. That is, from the experimental result that the visible light having the brightness which instantaneously increased was detected, it is considered that the through hole having a diameter of several 100 micrometers was instantaneously formed in the debris shield foil of zirconium by the large size debris. From the fact that the through hole was instantaneously formed in the zirconium foil having a thickness of 400 nm, it is considered that the considerably large size debris having considerably large kinetic energy was generated instantaneously. From the preliminary experimental result, since the silicon carbide ceramics is a polycrystalline consisting of a number of monocystalline substances, it is considered that the combination between the grain boundaries was broken by the sputtering action of the high temperature plasma and that the large size particle of monocystalline substance was generated and impinged on the debris shield foil. Therefore, if the high temperature plasma is shielded by use of the plasma shield device consisting of monocrystalline substance, it is possible to reduce the generation of the debris having large kinetic energy.

The plasma shield device according to the invention comprises the hollow structure having the internal space in which the plasma is to be produced and the first and second opening opposed to each other across the internal space, wherein the discharge gas is mainly supplied through the first opening and the plasma radiation is emitted through the second opening. Therefore, by equipping discharge electrodes or a discharge circuit on the outer circumference of the hollow structure, the plasma is produced in the internal space of the hollow structure and the generated plasma is effectively shielded by the plasma shield device. It is not necessary to arrange all of the components of the discharge circuit on the outer circumference of the hollow structure, and it is possible to arrange some components of the discharge circuit.

Furthermore, in the plasma generation apparatus of capillary type, the capillary pipe (insulation pipe) is composed of the hollow structure of monocystalline silicon carbide and the anode and cathode electrode may be provided at the ends of the capillary pipe, respectively. In this case, as the plasma is generated in the internal space of the capillary pipe, the plasma shield device according to the invention constructs the capillary pipe and the generated high temperature plasma is shielded by the capillary pipe consisting of the monocystalline silicon carbide.

The plasma source apparatus according to the invention comprising a discharge chamber in which a discharge head for generating plasma is arranged, an optical system chamber in which a light collection optical system for collecting EUV radiation emitted from the plasma is arranged, a filter device arranged between the discharge chamber and the optical system chamber to selectively transmit the EUV radiation emitted from the generated plasma, and a driving power supply, wherein

the discharge head comprises a hollow structure made of a monocrystal body of silicon carbide and having an internal space in which the plasma is generated and a first and second opening opposed to each other across the discharge space, and wherein

at least a component of a discharge circuit is arranged outer circumference of the hollow structure.

According to the invention, as the plasma is generated in the internal space of the hollow structure, the generated plasma is shielded by the plasma shield device having both of the heat resisting property and sputtering resistant property. As the result of this, the plasma source apparatus in which the generation of the debris is reduced can be realized.

As the filter device, the thin film of zirconium and various foil or thin film which selectively transmits EUV radiation and blocks the visible light can be used.

### Advantageous Effect of Invention

According to the invention, since the hollow structure composed of the monocrystalline of silicon carbide is used to generate the plasma in the internal space of the hollow structure, the plasma source apparatus in which the generation of the debris is substantially reduced can be realized. Especially, since the debris having large size is hard to be generated, the plasma source apparatus in which the life of the filter device is improved and the maintenance frequency is reduced can be realized. Further, according to the invention, it is possible to thin the thickness of the debris shield foil, and thus the transmittance of the filter device becomes still higher. As the result of this, the plasma source apparatus which can emit the EUV radiation having still higher intensity.

### BRIEF DESCRIPTION OF DRAWINGS

FIG. 1 is a view showing one example of the plasma source apparatus according to the invention.

FIG. 2A is a perspective view showing one example of the plasma shield device of the invention.

FIG. 2B is a sectional view showing one example of the plasma shield device of the invention.

FIG. 3A is a perspective view showing one example of the discharge head.

FIG. 3B is a sectional view showing one example of the discharge head taken along line II-II of FIG. 3A.

FIG. 4 is a view showing flowing direction of current in the discharge circuit.

FIG. 5 is a graph showing relation between thickness and transmittance of the zirconium foil.

FIG. 6 is a view showing one example of the discharge apparatus of capillary type.

### EMBODIMENTS OF INVENTION

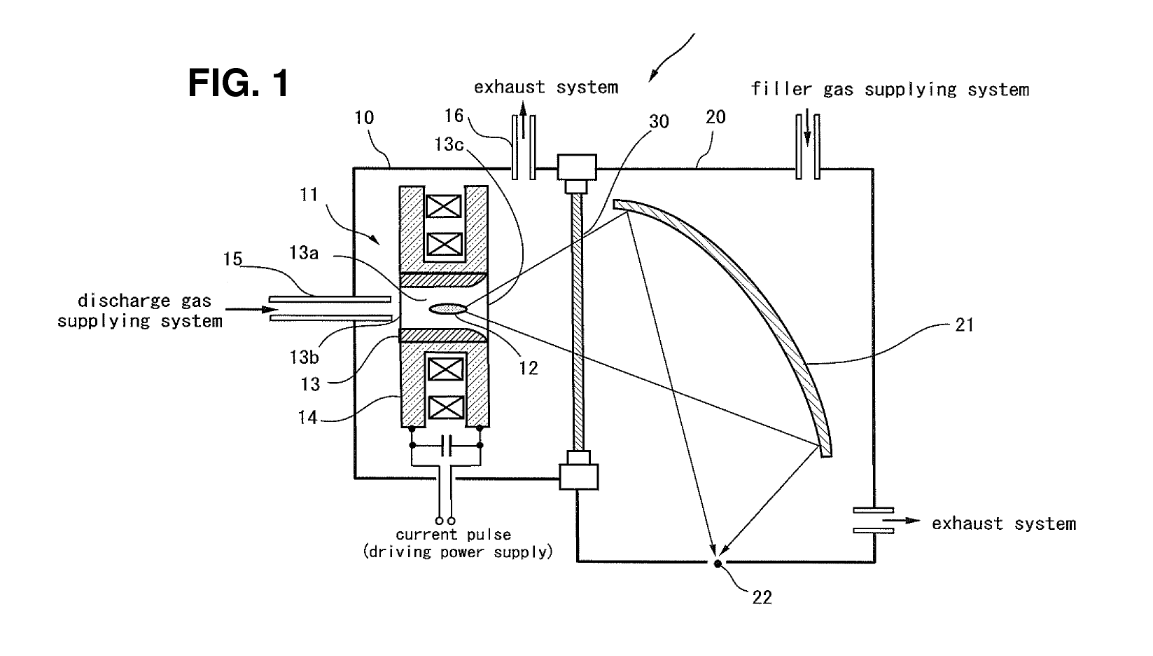

FIG. 1 is a view showing one example of the plasma source apparatus of the present invention. In the present example, the high temperature plasma is generated by using the plasma generation apparatus of DPP type in order to produce the EUV radiation whose wavelength is 13.5 nm, which is used for a lithography apparatus or mask inspection apparatus of the next generation. The plasma source apparatus 1 comprises a plasma generation chamber 10 (discharge chamber), optical system chamber 20 and a filter device (debris shield device) 30 for isolating the plasma chamber and the optical system chamber.

In the plasma generation chamber 10, there is arranged the discharge head 11 for generating the Z-pinch plasma. In the present example, the high temperature plasma is generated by inductively coupled plasma method (ICP method). The discharge head 11 comprises the plasma shield device 13 for shielding the generated plasma 12. The plasma shield device 13 comprises a hollow cylindrical structure composed of monocystalline silicon carbide. The plasma 12 is generated in the internal space of the plasma shield device 13. On the outer circumference of the plasma shield device 13, there is arranged a discharge circuit 14 for receiving current pulses and for generating the plasma. The discharge circuit 14 is connected to a driving power supply (not shown) through a capacitor bank and is supplied with direct current pulses through the capacitor bank at a constant period. The present invention may be applied to the plasma source apparatus in which some components of the discharge circuit are arranged on the outer circumference of the plasma shield device.

The plasma generation chamber 10 is provided with an inlet 15 for supplying discharge gas and an outlet 16 for exhausting the discharge chamber. As the discharge gas, xenon gas, tin gas, mixed gases of xenon gas and helium gas, and mixed gases of xenon gas, helium gas and argon gas can be used. The discharge gas supplied through the inlet 15 flows into the internal space 13a of the plasma shield device 13 through the opening 13b, and the plasma radiation produced from the plasma 12 and including the EUV radiation is emitted through another opening 13c of the plasma shield device 13.

The plasma radiation generated from the plasma 12 transmits through the filter device 30 and penetrates into the optical chamber 20. The filter device 30 functions as a debris shield device to prevent the generated debris from penetrating into the optical system chamber 30 and a filtering device to selectively transmit the EUV radiation emitted from the generated plasma 12. The filter device 30 may be composed of the thin film of zirconium. The thin film of zirconium is suitable for the filter device, because it transmits the EUV radiation whose wavelength is 13.5 nm and blocks the visible light. It is possible to use various foils for selectively transmitting the EUV radiation except the zirconium foil.

In the optical system chamber 20, there is arranged a collection optical system. The collection optical system comprises a concave mirror 21. The EUV radiation whose wavelength is 13.5 nm is collected at a middle collection point 22 by the concave mirror 21 and is used for various applications through an optical system arranged behind the collection optical system. The optical system chamber 20 is supplied with filler gas such as hydrogen or helium to keep the internal pressure constant value. It is preferable that the internal pressure of the discharge chamber 10 is equal to that of the optical system chamber 20. When the internal pressures of two adjacent chambers are equal to each other, an advantageous effect that the pressure acting to the zirconium foil from the opposite sides is balanced is achieved.

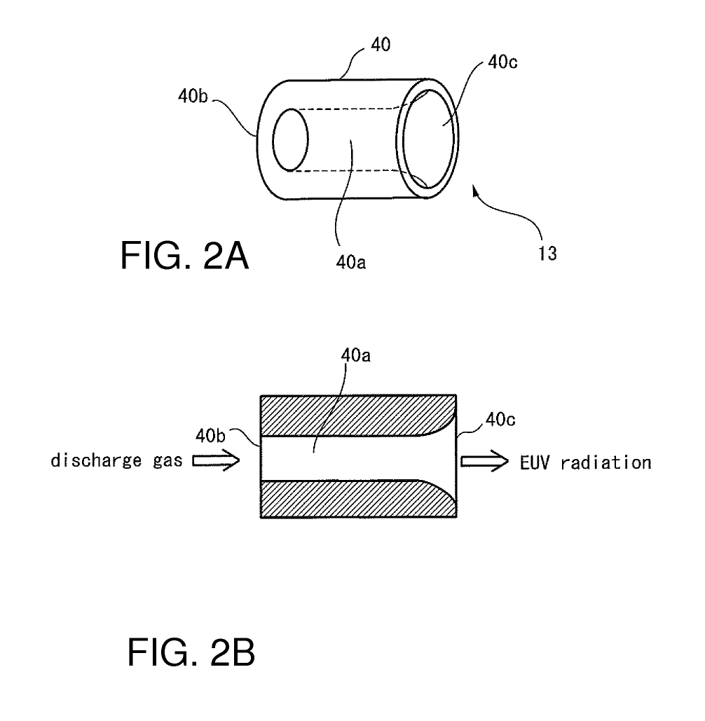

FIGS. 2A and 2B show one example of the plasma shield device, in which FIG. 2A is a perspective view and FIG. 2B is a sectional view. The plasma shield device 13 comprises a hollow cylindrical body 40. The internal space 40a forms a discharge space in which the high temperature plasma is generated during the operation of the plasma generation apparatus. The hollow cylindrical body has a first and second opening 40b and 40c which are opposed to each other across the internal space 40a. The discharge gas is mainly supplied to the internal space through the first opening 40b, and the EUV radiation produced from the plasma is mainly emitted through the second opening 40c. The second opening emitting the plasma radiation is tapered so that the opening angle increases toward the exterior, and thus the plasma radiation emits in a wide angle range. The discharge circuit for generating the plasma is fixed on the outer circumference of the hollow cylindrical body 40. The high temperature plasma is generated within the internal space 40a by supplying the current pulse to the discharge circuit.

In the above embodiment, as the plasma shield device, the hollow cylindrical body is used, but it is possible to use a hollow structure having a polygon such as tetragon.

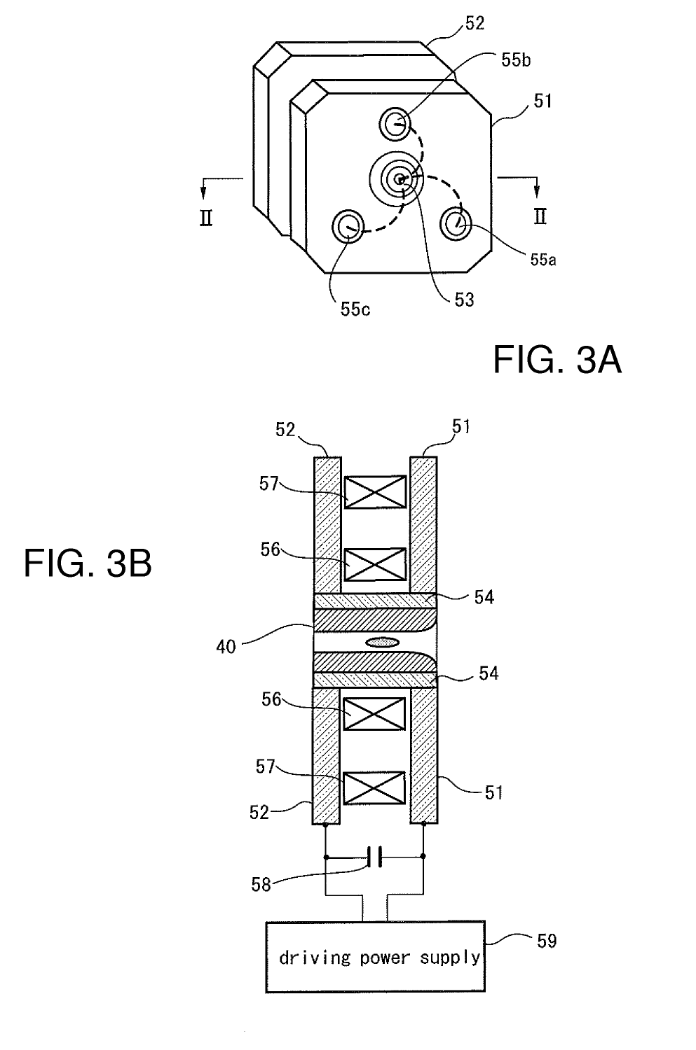

FIGS. 3A and 3B are views showing an example of the discharge head, in which FIG. 3A is a perspective view, and FIG. 3B is a line II-II sectional view of FIG. 3A. The discharge head 11 comprises a first and second metal plate 51 and 52 for forming the discharge circuit. These metal plates are opposed to each other with a given space. These metal plates may be composed of copper plate. A through hole is formed at the center of two metal plates, and such through hole forms a plasma discharge zone 53. A hollow metal cylinder 54 is joined inside of the through hole. The hollow cylindrical structure 40 consisting of monocrystalline silicon carbide is joined inside of the copper cylinder 54, and such hollow structure 40 forms the plasma shield device for shielding the generated high temperature plasma. Furthermore, three through holes 55a˜55c for forming a return passage for the plasma are formed in the metal plates 51 and 52, and a metal cylinder is joined inside of the through holes 55a˜55c, respectively. Therefore, the plasma loop is formed by three return passages around the discharge zone 53. In FIG. 3A, the return passage of the plasma loop is shown by broken lines.

Between two metal plates 51 and 52, there is arranged a first magnetic core 56 so as to surround the plasma discharge zone 53, and a second magnetic core 57 which constructs a magnetic switch is arranged outside of the three return passage. Two metal plates are provided with a cooling means so that the metal plates 51 and 52, the metal cylinder and the hollow structure 40 are cooled. Furthermore, a capacitor bank 58 is connected between the first and second metal plates 51 and 52 and is also connected to a driving power supply 59.

A primary circuit of the discharge circuit includes the first and second metal plate 51 and 52, metal cylinder 54, the first and second magnetic core 56 and 57, and the capacitor banal 58. A secondary circuit comprises the plasma loop.

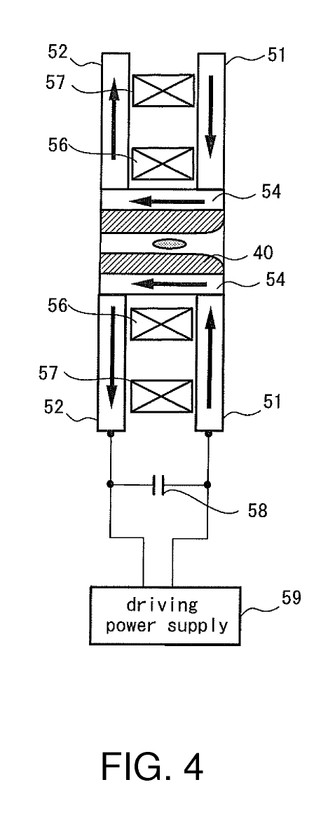

Next, the producing operation of the Z-pinch plasma will be explained. FIG. 4 shows a current passage when the current pulses are supplied to the discharge circuit. When the current pulse is emitted from the driving power supply 59, the capacitor bank starts to charge. In parallel, the electric current flows from the outer portion of the first metal plate 51 toward the central plasma discharge zone and impinges into the second metal plate 52 through the metal cylinder 54. When the second magnetic core 57 which constructs the magnetic switch is saturated, its inductance becomes to zero and thereby the charge stored in the capacitor bank flows along the first magnetic core 56. And thereby the electric current flows along the plasma loop which constructs the secondary circuit so as to produce the plasma current. By occurrence of the plasma current, a local magnetic field is formed around the plasma discharge zone and thereby the plasma generated in the discharge space is compressed to form the Z-pinch plasma and thus the EUV radiation is produced. In this case, even if the high temperature plasma is produced, the generation of the debris is substantially suppressed, because the plasma shield device is arranged between the generated plasma and the discharge circuit.

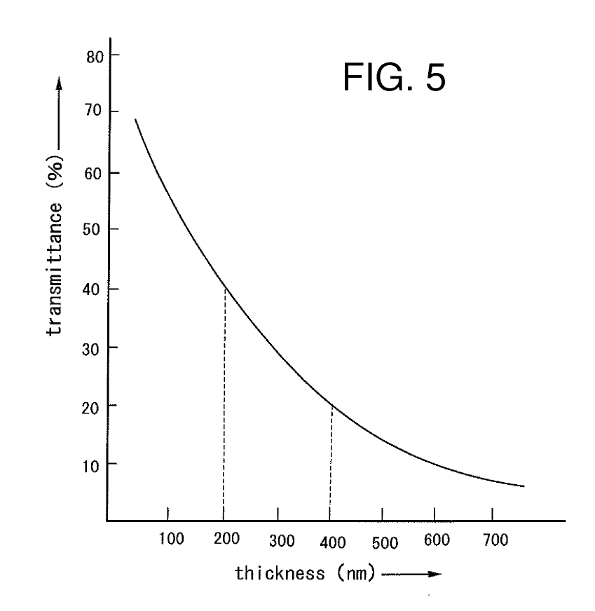

FIG. 5 is a graph showing a relation between the transmittance and thickness of the zirconium foil constructing the filter device. In FIG. 5, the vertical axis shows the transmittance and the abscissa shows the thickness of the zirconium foil. In the thickness range of 100˜500 nm, the transmittance falls as the film thickness increases. Therefore, if the thickness of the foil of zirconium may be thinned, the transmittance of the foil may increase considerably so that the loss caused by the filter device can be substantially improved. The thickness of zirconium foil which is put to practical use currently is set to 400 nm. When the thickness of the zirconium foil is 400 nm, its transmittance is about 20 percents. In the plasma source apparatus of the invention, the size of the generated debris is smaller to a cluster molecules level, and thus it is possible to thin the thickness of the zirconium foil. As the result of the inventor' experiments, it has been found that the thickness of the zirconium foil can be set to 200 nm. In this case, the transmittance of the foil becomes to 40 percents, and thus the advantageous effect can be achieved that the loss caused by the filter device can be substantially improved.

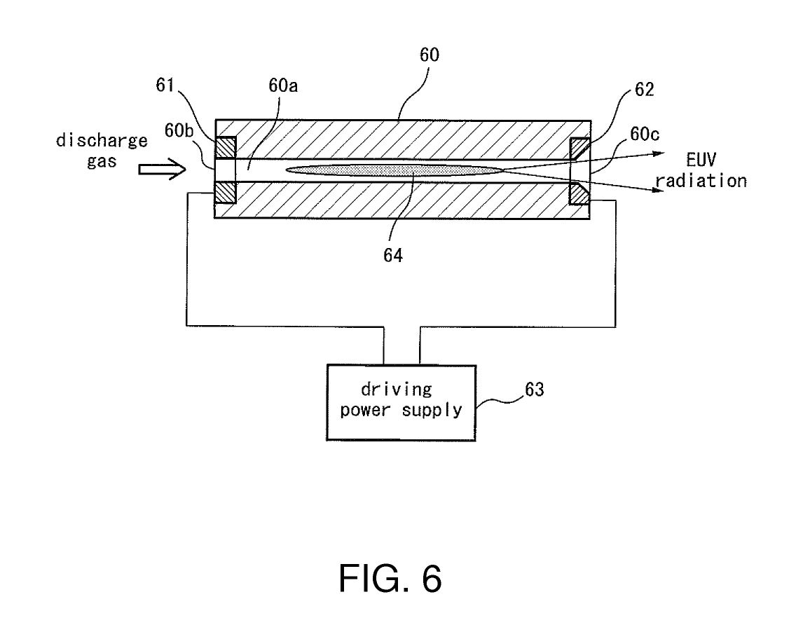

FIG. 6 shows the plasma generation apparatus of capillary type according to the invention. As a capillary pipe, a hollow cylindrical structure 60 composed of monocrystalline silicon carbide having high electric insulation quality is used. The hollow structure 60 has an internal space 60a in which the high temperature plasma is generated and a first and second opening 60b and 60c which are opposed to each other across the internal space. A ring shaped cathode electrode 61 which operates as a first main electrode is provided at one end of the hollow structure 60 and a ring shaped anode electrode which operates as a second main electrode is provided at the other end. Driving power supply 63 is connected between the cathode electrode 61 and the anode electrode 62.

When the current pulse of for example 1.5 kV and 5 kA is supplied from the driving power supply 63 to the anode and cathode electrode, the discharge occurs within the internal space to generate the high temperature plasma 64. The plasma radiation produced by the plasma 64 is emitted toward the exterior through the second opening 60c. In this plasma generation apparatus of capillary type, the capillary pipe is consisted of the monocrystalline silicon carbide, the capillary pipe in itself functions as the plasma shield device.

The present invention is not limited to the above-mentioned embodiments and can be modified and changed in various ways. For example, in the above-mentioned embodiment, the plasma generation apparatus of DPP type was explained, but the present invention can be applied to the plasma shield device used in the plasma generation apparatus of LPP type. Furthermore, the plasma generation method of ICP type was explained, but the present invention can be applied to various kinds of plasma generation apparatus except the ICP method.

As the monocrystalline silicon carbide, monocrystalline which is not added with a dopant and has high insulation quality can be used, and monocrystalline silicon carbide which is added with the dopant can also be used.

What is claimed is:

1. A plasma shield device used in a plasma generation apparatus and for shielding high temperature plasma, the plasma shield device comprising;
a hollow structure having an internal space, and a first and second opening which are opposed to each other across the inside of the internal space, wherein
the hollow structure comprises of monocrystal body of silicon carbide, and wherein
the internal space of the hollow structure forms a discharge space in which the plasma is generated during the operation of the plasma generation apparatus.

2. The plasma shield device of claim 1, wherein discharge gas is supplied to the internal space through the first opening and EUV radiation produced by the plasma is mainly emitted through the second opening.

3. The plasma shield device of claim 1, wherein the outer surface of the hollow structure is provided with a discharge circuit or some components of the discharge circuit which is connected to a driving power supply, and wherein
during the operation of the plasma generation apparatus, current pulses are supplied from the driving power supply to the discharge circuit so as to generate the high temperature plasma in the internal space of the hollow structure.

4. The plasma shield device of claim 1, wherein the first and second opening of the hollow structure are respectively provided with a first and second main electrode which are connected to the driving power supply, and wherein
during the operation of the plasma generation apparatus, the current pulses are supplied between the first and second electrodes so as to generate the high temperature plasma in the internal space of the hollow structure.

5. The plasma shield device of claim 4, wherein the plasma generation apparatus is a plasma generation apparatus of capillary type, and the hollow structure constructs a capillary pipe.

6. The plasma shield device of claim 2, wherein during the operation of the plasma generation apparatus, the discharge gas consisting of xenon gas or mixed gas including xenon gas is supplied to the internal space through the first opening, and the EUV radiation whose wavelength is about 13.5 nm is emitted through the second opening.

7. The plasma shield device of claim 5, wherein the second opening of the hollow structure is tapered so that the opening angle increases toward the exterior.

8. The plasma shield device of claim 1, wherein the hollow structure of the monocrystal body of the silicon carbide is manufactured from an ingot of the silicon carbide by way of machining processing.

9. A plasma source apparatus comprising a discharge chamber in which a discharge head for generating plasma is arranged, an optical system chamber in which a light collection optical system for collecting EUV radiation emitted from the plasma is arranged, a filter device arranged between the discharge chamber and the optical system chamber to selectively transmit the EUV radiation emitted from the generated plasma, and a driving power supply, wherein
the discharge head comprises a hollow structure made of a monocrystal body of silicon carbide and having an internal space in which the plasma is generated and a first and second opening opposed to each other across the discharge space, and wherein
at least a component of a discharge circuit is arranged outer circumference of the hollow structure.

10. The plasma source apparatus of claim 9, wherein discharge gas is supplied to the internal space through the first opening of the hollow structure, and the EUV radiation produced by the plasma is emitted through the second opening.

11. The plasma source apparatus of claim 9, wherein the first and second opening of the hollow structure are respectively provided with a first and second main electrode which are connected to the driving power supply, and wherein
during the operation of the plasma generation apparatus, the current pulses are supplied between the first and second main electrodes so as to generate high temperature plasma in the internal space of the hollow structure.

12. The plasma source apparatus of claim 9, wherein the filter device includes a foil or thin film which selectively transmits the EUV radiation whose wavelength is about 13.5 nm.

13. The plasma source apparatus of claim 9, wherein the filter device includes a foil of zirconium which transmits the EUV radiation whose wavelength is 13.5 nm and blocks visible light.
